(19) United States
(12) Patent Application Publication
(10) Pub. No.: US 2026/0369025 A1
(43) Pub. Date: Nov. 19, 2026

(54) INFORMATION PROCESSING DEVICE, INFORMATION PROCESSING METHOD, AND DISPLAY DEVICE

(71) Applicant: KYOCERA Corporation, Kyoto (JP)

(72) Inventors: Xiaoyan DAI, Yokohama-shi, Kanagawa (JP); Younghun KO, Eunpyeong-gu, Seoul (KR); Takehiro MABUCHI, Shinagawa-ku, Tokyo (JP); Hiroki TANIMOTO, Yokohama-shi, Kanagawa (JP); Satoshi NAGAHARA, Yokohama-shi, Kanagawa (JP); Takehiko KAWAI, Yokohama-shi, Kanagawa (JP); Kensuke TAGUCHI, Kawasaki-shi, Kanagawa (JP)

(73) Assignee: KYOCERA Corporation, Kyoto (JP)

(21) Appl. No.: 19/136,263

(22) PCT Filed: Dec. 4, 2023
(86) PCT No.: PCT/JP2023/043331

§ 371 Date: Jun. 5, 2025

(30) Foreign Application Priority Data
Dec. 6, 2022 (JP) 2022-194991

(51) Int. Cl. G06V 10/20

(52) U.S. Cl. CPC G06V 10/255

(57) ABSTRACT

An information processing device includes an acquisition unit and a control unit. The acquisition unit is configured to acquire a captured image of an item. The control unit is configured to display, on a display unit, at least one second candidate satisfying a prescribed condition from among a plurality of first candidates for which a recognition result for the item satisfies a prescribed confidence.

### CROSS-REFERENCE TO RELATED APPLICATIONS

This application claims priority based on Japanese Patent Application No. 2022-194991 filed Dec. 6, 2022, the entire disclosure of which is hereby incorporated by reference.

### TECHNICAL FIELD

The present disclosure relates to an information processing device, an information processing method, and a display device.

### BACKGROUND OF INVENTION

A known technology of the related art captures an image of an item with an imaging device or the like and recognizes what kind of item the item is, for the purpose of a payment process to pay for the item. For example, Patent Literature 1 discloses an information processing device provided with an image interface. The image interface acquires taken images of a prescribed place where a plurality of items are placed. For an item that could not be recognized among the plurality of items, the information processing device presents item candidates to a user, allowing the user to select the item.

### CITATION LIST

### Patent Literature

Patent Literature 1: International Publication No. 2019/181035

### SUMMARY

According to an embodiment of the present disclosure, an information processing device includes an acquisition unit and a control unit. The acquisition unit is configured to acquire a captured image of an item. The control unit is configured to display, on a display unit, at least one second candidate satisfying a prescribed condition from among a plurality of first candidates for which a recognition result for the item satisfies a prescribed confidence.

According to an embodiment of the present disclosure, an information processing method is configured to acquire a captured image of an item. The information processing method is configured to display, on a display unit, at least one second object candidate satisfying a prescribed condition from among a plurality of first candidates for which a recognition result for the item satisfies a prescribed confidence.

According to an embodiment of the present disclosure, a display device includes a display unit. The display unit is configured to display at least one first candidate satisfying a prescribed condition as a second candidate. The at least one first candidate is from among a plurality of first candidates that are recognition results satisfying a prescribed confidence for an item included in a captured image.

### BRIEF DESCRIPTION OF THE DRAWINGS

FIG. 1 is a schematic configuration of a payment system according to an embodiment of the present disclosure.

FIG. 2 is a schematic configuration of an information processing system illustrated in FIG. 1.

FIG. 3 is a block diagram of an information processing device illustrated in FIG. 2.

FIG. 4 is an image captured by an imaging unit according to an embodiment.

FIG. 5 is a list of first candidates according to an embodiment.

FIG. 6 is an image of second candidates displayed on a display unit according to an embodiment.

FIG. 7 is an image of second categories displayed on a display unit according to an embodiment.

FIG. 8 is a flowchart of an information processing method according to an embodiment.

FIG. 9 is a captured image displayed on a display unit according to variation 1.

FIG. 10 is an image emphasizing first items according to variation 1.

FIG. 11 is an image of second candidates displayed on a display unit according to variation 1.

FIG. 12 is a list of items easily misrecognized as a first item according to variation 2.

FIG. 13 is an image of third candidates displayed on a display unit according to variation 2.

FIG. 14 is a flowchart of an information processing method according to variation 2.

FIG. 15 is an image displayed on a display unit according to variation 3.

FIG. 16 is a captured image on a display unit according to variation 4.

FIG. 17 is an image of third candidates displayed on a display unit according to variation 4.

### DESCRIPTION OF EMBODIMENTS

When an item information processing device provided with an image interface is used to display a plurality of item candidates for an item that could not be recognized, items which are of high confidence as an item candidate, but which are not actually relevant, are presented to the user. At this time, the user receives useless information, which slows down decision-making for item selection.

According to an embodiment of the present disclosure, the user can quickly decide the correct item for an item that could not be recognized.

The following refers to the drawings to describe an embodiment of the present disclosure.

### System Configuration

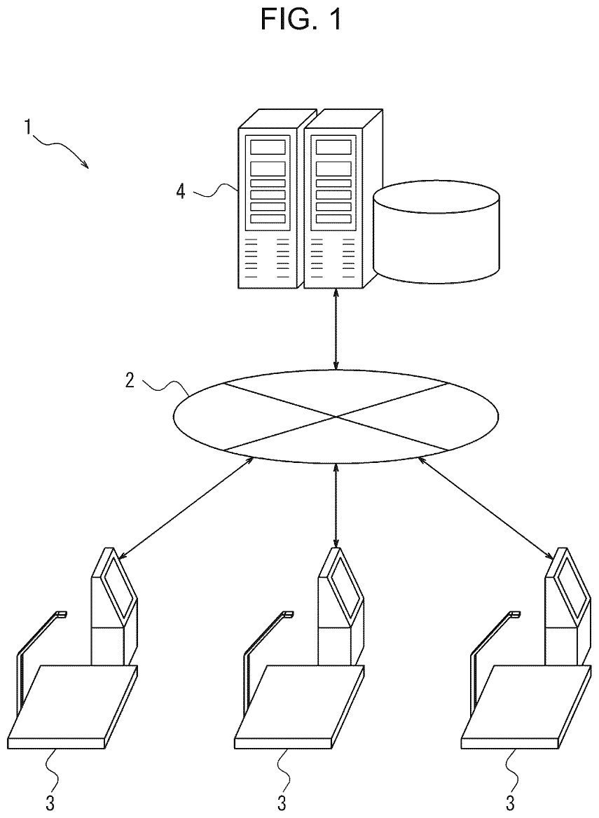

A payment system 1 as illustrated in FIG. 1 is configured as a point-of-sales (POS) system. The payment system 1 includes at least one information processing system 3 and a server 4. In the present embodiment, the payment system 1 includes a plurality of information processing systems 3.

The information processing system 3 and the server 4 can communicate over a network 2. The network 2 may be any network, including the Internet or the like.

The information processing system 3 may be provided in a store of any kind. For example, the information processing system 3 is provided in a convenience store, a supermarket, a restaurant, or the like.

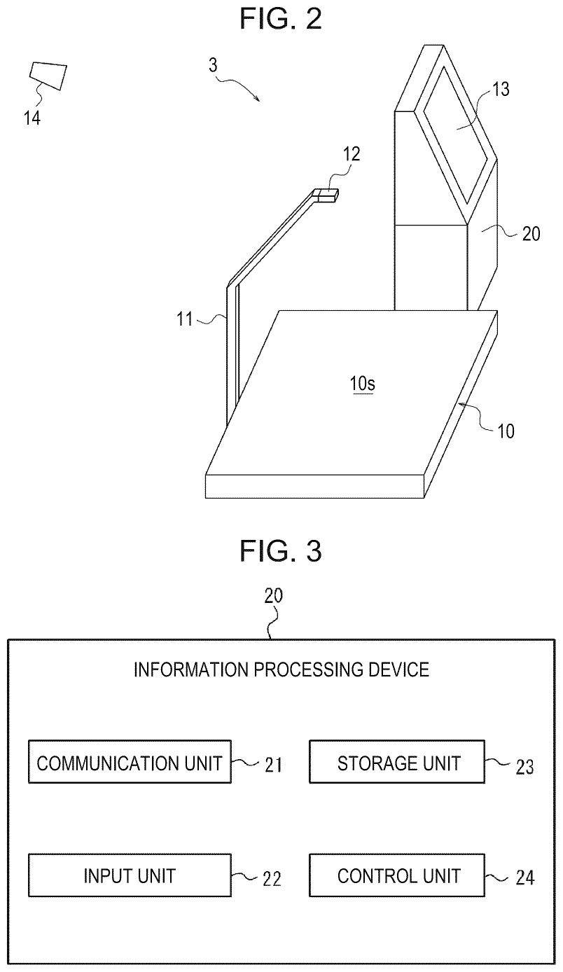

The information processing system 3 according to the present embodiment is configured as an unmanned register. An unmanned register is also referred to as a self-checkout register. Note that “register” is an abbreviation for “cash register”, and is used to pay for items to be purchased, for example. For example, in the information processing system 3, the user, who is a customer of a store, places an item to purchase on a placing table 10 as illustrated in FIG. 2. The information processing system 3 captures an image of the item placed by the user. The information processing system 3 recognizes whether an object included in the captured image generated by the image capture is any item in the store. Recognition of the item by the information processing system 3 allows for calculation of a total amount for the price of the item to be charged to the user. Multiple items may be placed on the placing table 10. The information processing system 3 is not limited to an unmanned register, and may also be a manned register or a semi-self-checkout register.

The information processing system 3 is configured as a register of a POS system. The information processing system 3 transmits a processing result, such as the total amount for the price of the items, information on individual items, and the prices of the items, to the server 4 over the network 2.

The server 4 receives the processing result of the information processing system 3 from the information processing system 3 over the network 2. On the basis of the received processing result, the server 4 manages the inventory status and the like of the store where the information processing system 3 is provided.

As illustrated in FIG. 2, the information processing system 3 includes a first imaging unit 12 and an information processing device 20. The information processing system 3 may further include the placing table 10, a support post 11, a display unit 13, and a second imaging unit 14. In the present embodiment, the information processing device 20 is configured as a separate device from the first imaging unit 12 and the display unit 13. However, the information processing device 20 may be configured in an integrated manner with at least one from among the display unit 13, the first imaging unit 12, the support post 11, the placing table 10, and the second imaging unit 14, for example.

The placing table 10 includes a top surface 10s. The top surface 10s is formed flat, to allow the user to place items to purchase thereon. In the present embodiment, the user places items to purchase directly on the top surface 10s, but the configuration is not limited thereto. The user may also place items contained in a shopping basket or a shopping bag. In the present embodiment, the top surface 10s is substantially rectangular, but is not limited thereto and may be any shape.

The support post 11 supports the first imaging unit 12. The support post 11 extends from a lateral part of the placing table 10 to above the top surface 10s. Note that the method of supporting the first imaging unit 12 is not limited to the support post 11. The support post 11 may support the first imaging unit 12 by any method that allows for image capture of at least a portion of the top surface 10s of the placing table 10.

The first imaging unit 12 is capable of generating an image by image capture. As an example, the first imaging unit 12 may be a camera with a lens. The first imaging unit 12 may be fixed so that the optical axis of the lens is perpendicular to the top surface 10s. For example, the first imaging unit 12 is fixed to allow for image capture of the entire top surface 10s of the placing table 10. The first imaging unit 12 may be fixed at the leading end of the support post 11. The first imaging unit 12 may execute image capture continuously at any frame rate. The first imaging unit 12 may capture a moving image.

The display unit 13 may be a display of any type. The display unit 13 displays an image transmitted from the information processing device 20. The display unit 13 may function as a touchscreen of an input unit 22 described later.

The second imaging unit 14 is capable of generating an image by image capture. The second imaging unit 14 is fixed to the ceiling above the placing table 10, and can capture an image of the placing table 10 and the surroundings thereof. As an example, the second imaging unit 14 may be a camera. An image captured by the second imaging unit 14 may include a user in front of the placing table 10 along with another user in line to use the information processing system 3. The second imaging unit 14 may capture an image of the placing table 10 from a different angle than the first imaging unit 12. By having the first imaging unit 12 and the second imaging unit 14 capture images of the placing table 10 from multiple angles, an item that cannot be recognized in the image captured by the first imaging unit 12 may be recognizable in the image captured by the second imaging unit 14 in some cases. The second imaging unit 14 may capture images continuously at any frame rate. The second imaging unit 14 may capture a moving image.

As illustrated in FIG. 3, the information processing device 20 includes a communication unit 21, an input unit 22, a storage unit 23, and a control unit 24.

The communication unit 21 includes at least one communication module that can connect to the network 2. The communication module may be a communication module that supports a standard such as local area network (LAN) or wireless LAN, for example. The communication unit 21 is connected to the network 2 by the communication module through a wired LAN or a wireless LAN.

The communication unit 21 includes a communication module that can communicate with the first imaging unit 12, the display unit 13, and the second imaging unit 14. The communication module supports a communication line standard. The communication by the communication unit 21 may be performed in a wired and/or wireless way. The communication unit 21 uses the communication module to function as an acquisition unit that acquires an image of an item placed on the top surface 10s of the placing table 10 from at least one of the first imaging unit 12 or the second imaging unit 14. The communication unit 21 may also use the communication module to communicate with a weight sensor 81 described later.

The input unit 22 can accept input from a user. The input unit 22 includes at least one input interface that can accept input from a user. The input interface is, for example, a physical key, a capacitive key, a pointing device, a microphone, or a touchscreen integrated with the display unit 13. In the present embodiment, the input unit 22 is a touchscreen integrated with the display unit 13, and acquires user input.

The storage unit 23 includes at least one semiconductor memory, at least one magnetic memory, at least one optical memory, or a combination of at least two of the above. The semiconductor memory is random access memory (RAM) or read-only memory (ROM), for example. The RAM is static random access memory (SRAM) or dynamic random access memory (DRAM), for example. The ROM is electrically erasable programmable read-only memory (EEPROM), for example. The storage unit 23 may function as main memory, auxiliary memory, or cache memory. The storage unit 23 stores data to be used in operations by the information processing device 20 and data obtained through operations by the information processing device 20.

The control unit 24 includes at least one processor, at least one special-purpose circuit, or a combination thereof. The processor is a general-purpose processor, such as a central processing unit (CPU) or a graphics processing unit (GPU), or a special-purpose processor specialized in specific processing. The special-purpose circuit is a field-programmable gate array (FPGA) or an application-specific integrated circuit (ASIC), for example. The control unit 24 executes processing related to operations by the information processing device 20 while controlling each unit of the information processing device 20.

The control unit 24 recognizes an item placed on the top surface 10s of the placing table 10, as acquired by the communication unit 21. The control unit 24 extracts a recognition result satisfying a prescribed confidence condition as a first candidate 40. Confidence is an indicator representing the likelihood of a recognition result regarding a placed item. The first candidate 40 includes a plurality of recognition results (for example, first candidates 40a to 40h), which are recognition results having at least a prescribed confidence. In the description hereinafter, the first candidates 40a to 40h may be referred to as the first candidates 40 when being referred to collectively, and as the first candidates 40a to 40h when referring to the individual items included in the first candidates 40. The control unit 24 transmits a signal to the display unit 13 via the communication unit 21. The signal is for displaying at least one second candidate 41 that further satisfies a prescribed condition from among the first candidate 40. The prescribed condition is for extracting only an item related to an item that has a high probability of being the placed item from among the first candidates 40. The second candidate 41 is an item related to an item that has a high probability of being the placed item from among the first candidates 40. When the display unit 13 and the information processing device 20 are configured as a single device, the control unit 24 may transmit a signal to the display unit 13 without going through the communication unit 21.

### Display Process

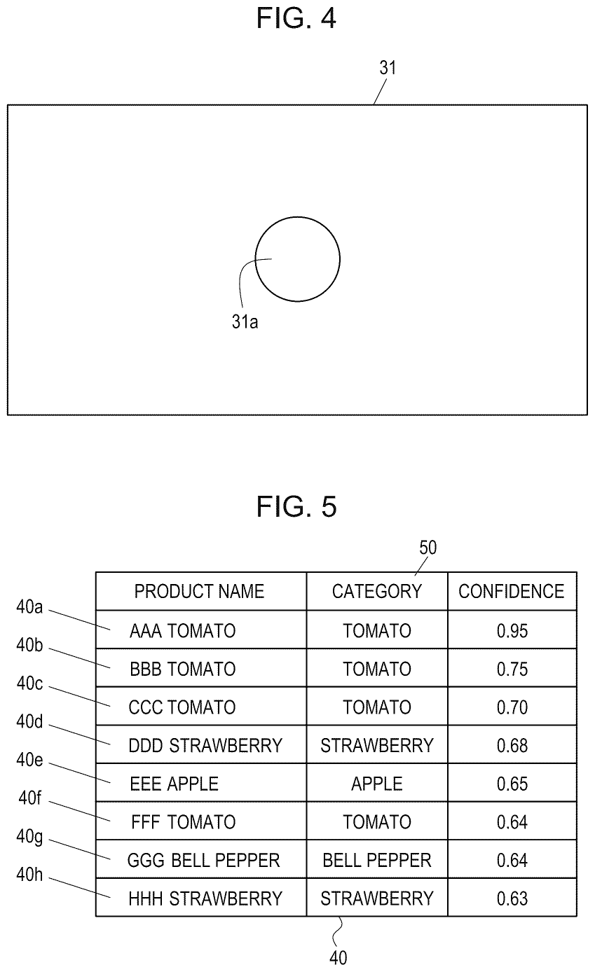

The following uses FIGS. 4, 5, and 6 to describe a process from the start of accounting to the finalization of a recognition result.

The control unit 24 may accept, via the input unit 22, input giving an instruction to start accounting. The input may be entered from the input unit 22 by a user who wants to do the accounting for an item. The user, upon entering this input from the input unit 22, places the item to purchase on the top surface 10s of the placing table 10. The user may also input the input giving an instruction to start accounting into the input unit 22 after placing an item on the top surface 10s of the placing table 10.

The control unit 24 acquires a captured image 31 captured by the first imaging unit 12 or the second imaging unit 14. FIG. 4 illustrates an example of the acquired captured image 31. The captured image 31 includes an image of a first item 31a that the user placed on the top surface 10s of the placing table 10. The control unit 24 may acquire captured images 31 captured by the first imaging unit 12 and the second imaging unit 14. In the present embodiment, the control unit 24 acquires the captured image 31 by receiving, via the communication unit 21, the captured image 31 captured by the first imaging unit 12.

The control unit 24 performs object recognition on the first item 31a included in the acquired captured image 31, and extracts a plurality of first candidates 40a to 40h, which are recognition results satisfying a prescribed confidence. FIG. 5 is an example of the first candidates 40. When extracting item names of the plurality of first candidates 40a to 40h, the control unit 24 may extract a category to which each item belongs, along with the confidence that the first item 31a is that item. In the present embodiment, the control unit 24 executes object recognition processing on the captured image 31 and extracts, as the first candidate 40, an item name that probably corresponds to the first item 31a due to the recognition result satisfying a prescribed confidence. The object recognition processing involves detecting an image of an item included in a captured image and estimating what kind of item the item is. The control unit 24 may execute the object recognition processing by using a learning model generated by machine learning, such as deep learning. In the present embodiment, the control unit 24 extracts eight first candidates 40, but is not limited thereto, and may simply extract two or more first candidates. Note that the object recognition processing is not limited to being executed by the control unit 24 of the information processing device 20, and may be executed by an external server or the like. When the object recognition processing is executed by an external server, more specifically, the external server receives a captured image via the communication unit 21, and the server executes the object recognition processing. When the object recognition processing is performed by an external server, the control unit 24 acquires a recognition result from the external server via the communication unit 21. A recognition result regarding an object may be anything that can be used to specify information such as the name of an item or an ID that can be used to specify an item. The control unit 24 may acquire an item name corresponding to a specified ID by using a correspondence table or the like stored in the storage unit 23.

The control unit 24 specifies a first category 51 that satisfies a prescribed condition from among categories 50 to which the first candidates 40a to 40h belong. Categories are classifications for categorizing items. Information on which categories items belong to may be stored in the storage unit 23. Categories include, for example, shapes of items, types of items, and types of packaging. More specifically, shapes of items may be categorized into categories according whether an item has a spherical shape, a cubic shape, an elongated shape, or the like. Types of items may be categorized into categories according to whether an item is a vegetable, a fruit, a confection, or the like. Types of packaging may be categorized into categories according to when an item is boxed, bagged, wrapped, or the like. An item may be deemed to belong to only one category or to multiple categories. The prescribed condition includes a condition such as being the category to which belongs the greatest number of the first candidates 40 from among the categories 50 to which each of the first candidates 40a to 40h belongs, or being the category to which belongs the first candidate 40 with the highest confidence from among the plurality of first candidates 40. In the present embodiment, the control unit 24 aggregates the categories 50 to which the first candidates 40a to 40h belong, and specifies the category to which belongs the greatest number of the first candidates 40 as the first category 51.

For example, the control unit 24 references the categories 50 to which the first candidates 40a to 40h belong. In the present embodiment, “tomato” is referenced as the category 50 to which the first candidates 40a, 40b, 40c, and 40f belong. “Strawberry” is referenced as the category 50 to which the first candidates 40d and 40h belong. “Apple” is referenced as the category 50 to which the first candidate 40e belongs. “Bell pepper” is referenced as the category 50 to which the first candidate 40g belongs. The control unit 24 calculates the number of first candidates 40 belonging to each referenced category 50. In the present embodiment, the breakdown of the numbers of first recognition results belonging to the referenced categories 50 is as follows: four for “tomato”, two for “strawberry”, one for “apple”, and one for “bell pepper”. On the basis of the calculated numbers of first candidates 40 belonging to the categories 50, the control unit 24 specifies the first category 51, that is, the category to which belongs the greatest number of the first candidates 40. In the present embodiment, “tomato” is specified as the first category 51. In the present embodiment, the categories 50 are types of vegetables, but are not limited thereto. Categories may any kind of concept broader than specifying information (for example, item names) that can be used to specify items.

The control unit 24 determines the first candidates 40 belonging to the first category 51 as the second candidates 41. In the present embodiment, “AAA tomato”, “BBB tomato”, “CCC tomato”, and “FFF tomato” are determined as the second candidates 41, as these belong to the “tomato” category which is the first category 51 to which the greatest number of the first candidates 40 belong from among the categories to which the plurality of first candidates 40 belong.

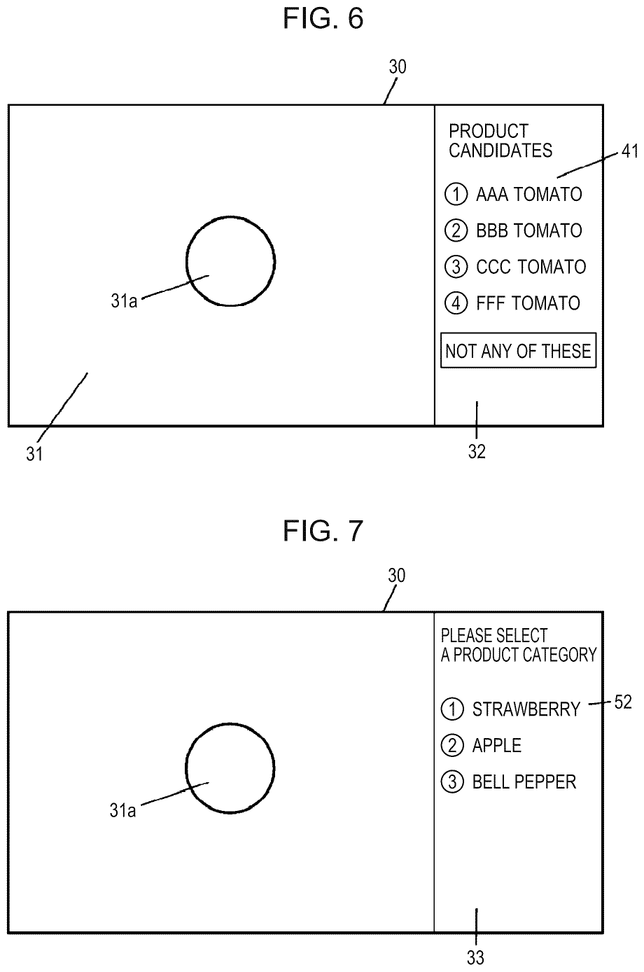

The control unit 24 displays an image 30 on the display unit 13. FIG. 6 illustrates an example of the image 30. The image 30 includes the captured image 31 and an image 32. The captured image 31 may be displayed on the left side of the display unit 13, and the image 32 may be displayed on the right side of the display unit 13. The captured image 31 is an image captured by the first imaging unit 12. The captured image 31 includes an image of a first item 31a that the user placed on the top surface 10s of the placing table 10. In the image 32, the item names of the second candidates 41 determined by the control unit 24 are displayed. In the image 32, the item names of the second candidates 41 and registered images of the items may be displayed together with information pertaining to the prices of the items or the like. The image 32 may include an image indicating “Not any of these” as a button for correcting the second candidates 41. The button for correcting the second candidates 41 may be used to input an indication that the first item 31a is not included among the second candidates 41. The item names of a plurality of items determined as second candidates 41 to be displayed in the image 32 may be displayed in descending or ascending order of confidence with respect to the recognition results regarding the plurality of items determined as the second candidates 41. Such a configuration helps the user more easily check which items have a highly accurate recognition result. The display order of the item names of a plurality of items determined as second candidates 41 to be displayed in the image 32 may be changeable on any basis by an operation on the input unit by the user.

When the image 30 is displayed on the display unit 13, the user checks the second candidates 41 displayed on the display unit 13. For example, the user looks at “AAA tomato”, “BBB tomato”, “CCC tomato”, and “FFF tomato” displayed in the image 32 included in the image 30, and checks whether these include the correct item name for the first item 31a. If the item name of the first item 31a is included among the second candidates 41, the user selects the display of the relevant item name. For example, the user selects “AAA tomato”, which is the item name of the first item 31a, from among the displays of “AAA tomato”, “BBB tomato”, “CCC tomato”, and “FFF tomato”. The control unit 24 finalizes the second candidate 41 selected by the user as the recognition result. For example, the control unit 24 finalizes “AAA tomato” selected by the user as the recognition result.

In this way, the second candidates 41 that satisfy a prescribed recognition condition from among the first candidates are displayed, rather than displaying all first candidates 40 that satisfy a prescribed confidence. This can help the user to decide the correct candidate quickly by checking only more accurate and fewer candidates.

Note that the display process described above need not be performed on all items included in the acquired captured image 31. More specifically, the control unit 24 may execute the display process on only an item for which the first candidate 40 with the highest confidence is not higher than a certain confidence, from among first candidates 40 extracted by performing the object recognition processing on a plurality of items. Specifically, the control unit 24 may perform the display process only in the case where all of the first candidates 40a to 40h fall below a prescribed confidence. For example, if the first candidate 40a with the highest confidence exceeds the prescribed confidence, the control unit 24 may not perform the display process and instead finalize the first candidate 40a as the final recognition result. Alternatively, the control unit 24 may simply execute the display process only on an item defined in advance to be an easily misrecognized item. Specifically, the control unit 24 may simply execute the display process when the first candidate 40a with the highest confidence from among the first candidates 40a to 40h is defined at or before accounting to be an easily misrecognized item. An easily misrecognized item is an item for which the recognition result has been corrected by other users a number of times exceeding a prescribed number of times, an item for which the similarity of feature information used in recognition processing satisfies a prescribed similarity, or the like.

### Re-Display Process

The following uses FIG. 7 to describe a process of displaying third candidates 42 when the item name of the first item 31a is not included among the displayed second candidates 41. The third candidates 42 are items newly estimated to have a high probability of being the item name of the first item 31a in a case where the item name of the first item 31a is not included among the second candidates 41.

When the correct item name of the first item 31a is not included among the second candidates 41, that is, when the first item 31a is misrecognized, the user enters input indicating as much into the input unit 22. For example, the user enters input by touching the image indicating “Not any of these” in the image 32. Note that the control unit 24 may also determine that the first item 31a is misrecognized when the user does not enter any input into the input unit 22 for a prescribed time or longer.

Upon accepting input indicating that the first item 31a is misrecognized, the control unit 24 again references the categories 50 to which the first candidates 40 belong. In the present embodiment, as described above, “tomato”, “strawberry”, “apple”, and “bell pepper” are referenced as the categories 50 to which the first candidates 40 belong. The control unit 24 determines, as a second category 52, at least one category 50 different from the first category 51 from among the referenced categories 50. In the present embodiment, the first category 51 is “tomato”, and therefore the control unit 24 determines “strawberry”, “apple”, and “bell pepper”, excluding “tomato”, from among the referenced categories 50 as second categories 52.

The control unit 24 displays an image 33 on the display unit 13. FIG. 7 illustrates an example of the image 33. In the image 33, the category names of the determined second categories 52 are displayed. In the present embodiment, “strawberry”, “apple”, and “bell pepper” determined as the second categories 52 are displayed in the image 33. At this time, information pertaining to the confidence of each category or the like may also be displayed in the image 33. The confidence of a category may be calculated on the basis of the confidence of the first candidate 40 belonging to the category. For example, the control unit 24 may use, as the confidence of a category, the average confidence of all first candidates 40 belonging to the category, or the confidence of the first candidate 40 which belongs to the category and which has the highest confidence. The category names displayed in the image 33 may be displayed in descending or ascending order of the confidence of the categories. This helps the user more easily check which categories have a high accuracy as the category to which the first item 31a belongs. As another example, the control unit 24 may display the categories 50 in descending order of the most first candidates 40 belonging to the categories 50.

When the image 33 is displayed on the display unit 13, the user checks the second categories 52 displayed on the display unit 13. If the category to which the first item 31a belongs is included among the second categories 52, the user selects the relevant category from among the second categories 52. The control unit 24 displays a plurality of first candidates 40 belonging to the selected second category 52 as the third candidates 42 in the image 32. The process thereafter is the same and/or similar to the display process and the re-display process described above.

If the category to which the first item 31a belongs is not included among the second categories 52, the user enters input into the input unit 22 to indicate that the second categories 52 are not correct. Note that the control unit 24 may also determine that the second categories 52 are not correct when the user does not enter any input into the input unit 22 for a prescribed time or longer.

Upon accepting input indicating that the second categories 52 are not correct, the control unit 24 instructs the display unit 13 to present a display prompting the user to input the correct category name to which the first item 31a belongs. The user enters the category name upon checking the display prompting for input of the category name. The control unit 24 displays items belonging to the entered category name on the display unit 13. Note that the control unit 24 may also prompt the user to input the item name of the first item 31a instead of the category name.

### Operations by System

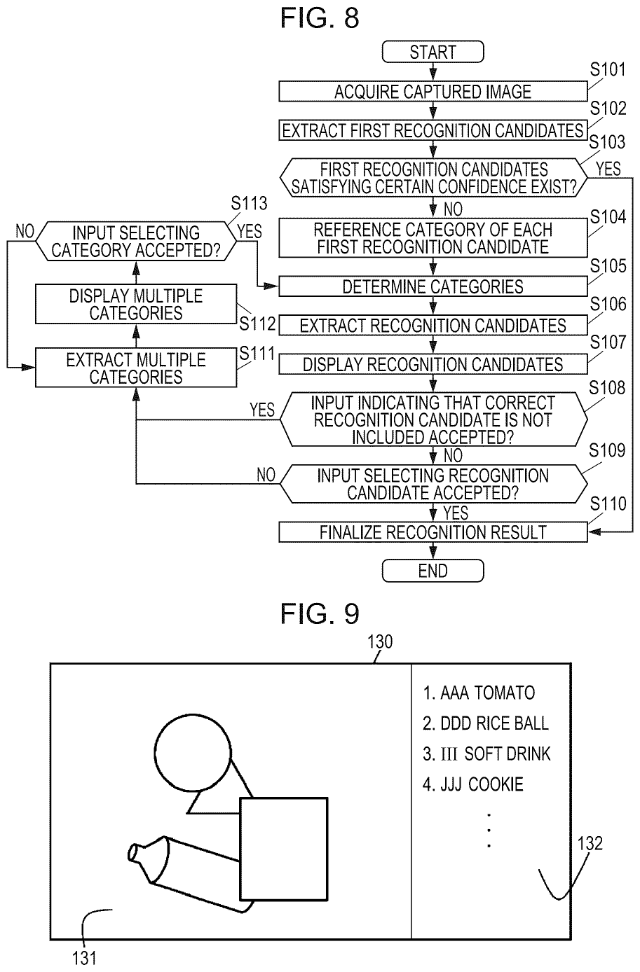

FIG. 8 is a flowchart illustrating a procedure of an information processing method according to an embodiment of the present disclosure. The information processing method includes steps S101 to S111. For example, the control unit 24 starts the processing in step S101 upon accepting, via the input unit 22, input giving an instruction to start accounting.

The control unit 24 acquires the data of the captured image 31 by receiving, via the communication unit 21, an image from the first imaging unit 12 (step S101). The control unit 24 executes object recognition processing on the captured image 31 acquired by the processing in step S101, and extracts first candidates 40 (step S102).

The control unit 24 determines whether or not the first candidates 40 extracted by the processing in step S102 include a plurality of first candidates 40 for which the recognition result satisfies a certain confidence (step S103).

If a plurality of first candidates 40 for which the recognition result satisfies a certain confidence are included (step S103: YES), the control unit 24 proceeds to step S104.

If a plurality of first candidates 40 for which the recognition result satisfies a certain confidence are not included (step S103: NO), the control unit 24 proceeds to step S110.

The control unit 24 references the categories 50 to which belong the first candidates 40 extracted by the processing in step S102 (step S104). For example, the control unit 24 references “tomato”, “strawberry”, “apple”, and “bell pepper”, which are the categories 50 to which the first candidates 40 belong.

The control unit 24 determines a first category 50a that satisfies a prescribed condition from among the categories 50 referenced by the processing in step S104 (step S105). In the present embodiment, the category “tomato” to which the greatest number of the first candidates 40 belong from among the referenced categories 50 is set as the first category 51.

The control unit 24 extracts, as second candidates 41, first candidates 40 that belong to the first category 51 determined by the processing in step S105 (step S106). In the present embodiment, “AAA tomato”, “BBB tomato”, “CCC tomato”, and “FFF tomato” which belong to the “tomato” category determined as the first category 51 are extracted as the second candidates 41.

The control unit 24 displays the second candidates 41 extracted by the processing in step S106 on the display unit 13 (step S107). For example, the control unit 24 displays the image 30 on the display unit 13.

The control unit 24 determines whether or not input has been accepted via the input unit 22 to indicate that the correct item name of the first item 31a is not included among the second candidates 41 (step S108).

Upon accepting, via the input unit 22, input indicating that the correct item name is not included (step S108: YES), the control unit 24 proceeds to the processing in step S111. For example, upon accepting, via the input unit 22, touch input on the partial image indicating “Not any of these” displayed within the image 32, the control unit 24 determines that input has been accepted via the input unit 22 to indicate that the correct item name is not included.

In the case of not accepting, via the input unit 22, input indicating that the correct recognition result is not included (step S108: NO), the control unit 24 proceeds to step S109.

The control unit 24 determines whether or not input has been accepted via the input unit 22 to select a second candidate 41 within a prescribed time (step S109).

Upon accepting, via the input unit 22, input selecting a second candidate 41 within a prescribed time (step S109: YES), the control unit 24 proceeds to step S110. For example, upon accepting, via the input unit 22, touch input on a second candidate 41 displayed within the image 32, the control unit 24 determines that input selecting the second candidate 41 has been accepted via the input unit 22.

If input selecting a second candidate 41 is not accepted via the input unit 22 within a prescribed time (step S109: NO), the control unit 24 proceeds to step S111. For example, in the case where touch input on a second candidate 41 displayed within the image 32 is not accepted within a prescribed time, the control unit 24 determines that input selecting a second candidate 41 has not been accepted via the input unit 22.

In the processing in step S110, the control unit 24 finalizes the second recognition result 41 selected by the user as the recognition result. Once the recognition result is finalized, the user pays for the purchase item on the basis of the recognition result.

In the processing in step S111, the control unit 24 extracts second categories 52, excluding the first category 51, from the categories 50 to which belong the first candidates 40 extracted in step S102. In the present embodiment, from among the categories 50 of “tomato”, “strawberry”, “apple” and “bell pepper” to which the first candidates 40 belong, “strawberry”, “apple” and “bell pepper”, excluding the first category 51 of “tomato”, are extracted as second categories 52.

In the processing in step S112, the control unit 24 displays the second categories 52 extracted in step S111 on the display unit 13. For example, the control unit 24 displays the image 33 on the display unit 13.

The control unit 24 determines whether or not input has been accepted from the user to select a second category 52 displayed on the display unit 13 within a prescribed time (step S113).

Upon accepting, from the user, input selecting a second category 52 within a prescribed time (step S113: YES), the control unit 24 returns to step S105. The selected second category 52 is handled as the first category 51 in the processing from step S105. For example, upon accepting, via the input unit 22, touch input on a second category 52 displayed within the image 33, the control unit 24 determines that input selecting the second category 52 has been accepted via the input unit 22.

If input selecting a second category 52 is not accepted from the user within a prescribed time (step S113: NO), the control unit 24 returns to step S111. For example, upon accepting, via the input unit 22, touch input on a second category 52 displayed within the image 33, the control unit 24 determines that input selecting the second category 52 has been accepted via the input unit 22.

Note that if input selecting a second category 52 is not accepted from the user within a prescribed time (step S113: NO), the control unit 24 may not return to step S111, and instead perform processing to present on the display unit 13 a display prompting for input of the correct category. The user may enter the correct category into the input unit 22 in response to the display prompting for input of the correct category. Once the input unit 22 accepts input of the correct category, the control unit 24 returns to step S105. At this time, the entered correct category is handled as the first category 51 in the processing from step S105.

As described above, in the information processing device 20, the control unit 24 does not present every possibility as an item recognition result to the user via the display unit 13, but rather displays only items belonging to a category that satisfies a prescribed condition.

According to such a configuration, fewer item names can be displayed as item recognition results, which enables the user to quickly decide and select the correct item name.

### Variation 1

The following describes variation 1. Note that description is omitted for portions of the process that overlap with the display process described above.

The embodiment described above describes the case where a single item is placed on the placing table 10, but as in variation 1, multiple items may also be placed on the placing table 10 to perform recognition on the items. The control unit 24 displays an image 130 on the display unit 13. FIG. 9 illustrates an example of the image 130. In FIG. 9, unlike the case of FIG. 6, multiple items are included in a captured image 131. In FIG. 9, unlike the case of FIG. 6, an image 132 includes recognition results obtained by performing object recognition processing on the multiple items included in the captured image 131.

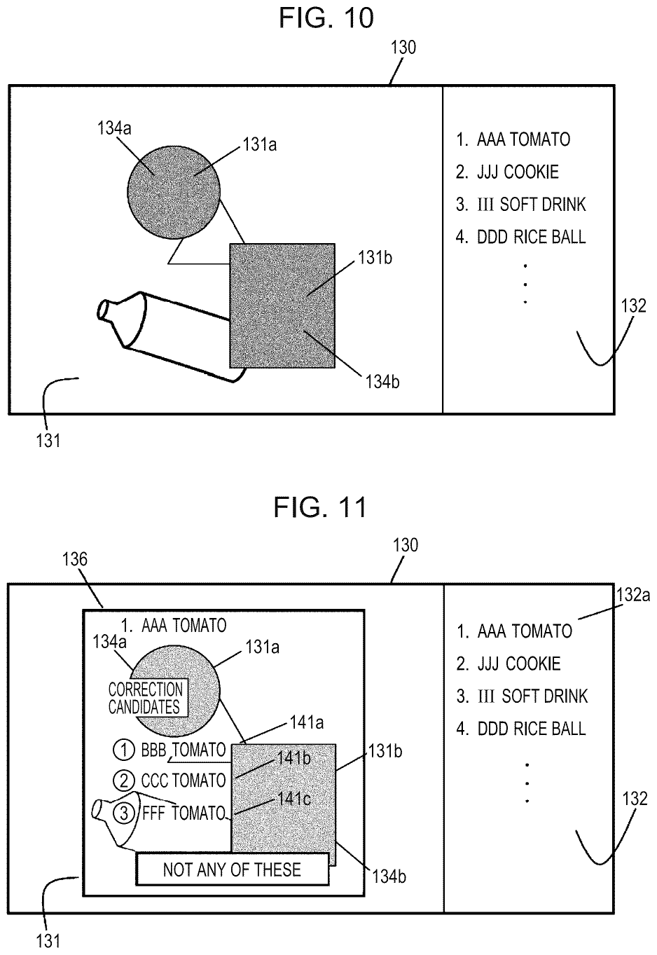

The control unit 24 may display, on the display unit 13, emphasis images 134a and 134b superimposed onto a first item 131a and a second item 131b, respectively, from among the item displayed in the captured image 131. FIG. 10 illustrates an example of the image 130 displayed on the display unit 13 at this time. When displaying the superimposed emphasis images 134a and 134b, the control unit 24 may also display emphasis images 135a and 135b superimposed on a first recognition result 132a that is the recognition result for the first item 131a and a second recognition result 132b that is the recognition result for the second item 131b, respectively. The first item 131a is, for example, the item for which a first candidate 140a with the highest confidence is not higher than a certain confidence, from among first candidates 140 extracted by performing the object recognition processing. The first item 131a may also be, for example, an item defined in advance to be an easily misrecognized item. The second item 131b is the same and/or similar to the first item 131a.

If the first recognition result 132a is wrong, the user enters input for correcting the first recognition result 132a into the input unit 22. The input for correction may be input selecting the first recognition result 132a on the display unit 13, input selecting the first item 131a on which the emphasis image 134a is superimposed, or input pressing a button for correcting the recognition result included on the information processing device 20 or in the image 130.

Upon accepting, via the input unit 22, input for correcting the first recognition result 132a, the control unit 24 additionally displays an image 136 in the image 130. FIG. 11 illustrates an example of the image 136 at this time. The image 136 may be included within the image 130, displayed in the same area as the image 132, or displayed in a different area from the captured image 131 and the image 132. It is also possible to display only the image 136, without displaying the captured image 131 or the image 132. The displayed image 136 includes the first recognition result 132a and a second candidate 141 with a high probability of being the item name of the first item 131a. The image 136 displayed at this time includes one or more second candidates 141. The second candidates 141 are candidates determined by the display process described above. The displayed image 136 may include a button for inputting an indication that the first item 131a is not included among the second candidates 141. For example, the displayed image 136 may include an image indicating “Not any of these” as the button for inputting an indication that the first item 131a is not included among the second candidates 141.

When the image 136 is displayed on the display unit 13, the user checks the second candidates 141. The user checks the second candidates 141, and if an item name that is correct as the item name of the first item 131a is included, the user selects the second candidate 141 with the relevant item name. The control unit 24 finalizes the second candidate 141 selected by the user as the recognition result.

If the user checks the second candidates 141 and the item name of the first item 131a is not included, the user enters input into the input unit 22 to indicate that the first item 131a is not included among the second candidates 141. For example, the user enters input by touching the image indicating “Not any of these” in the image 136. Note that the control unit 24 may also determine that the first item 131a is not included among the second candidates 141 when the user does not enter any input into the input unit 22 for a prescribed time or longer.

Upon accepting, via the input unit 22, input indicating that the first item 131a is not included among the second candidates 141, the control unit 24 performs the re-display process described above on the first item 131a. Variation 1 describes correcting the recognition result for the first item 131a from among multiple items, but the same and/or similar process can also be performed on the second item 131b.

### Variation 2

The following describes variation 2. Note that description is omitted for portions of the process that overlap with the display process described above.

The embodiment described above describe the case where, if the correct item is not among the second candidates 41, the user is prompted to select a second category 52, and third candidates 42 are displayed on the display unit 13. However, third candidates 42 may be displayed on the display unit 13 without prompting the user to select a second category 52. The image 30 is displayed on the display unit 13, and the user checks the second candidates 41 displayed on the display unit 13. At this time, if the correct item name of the first item 31a is not included among the second candidates 41, the user enters input by touching the image indicating “Not any of these”. Since the details are the same and/or similar to the re-display process described above, description is omitted.

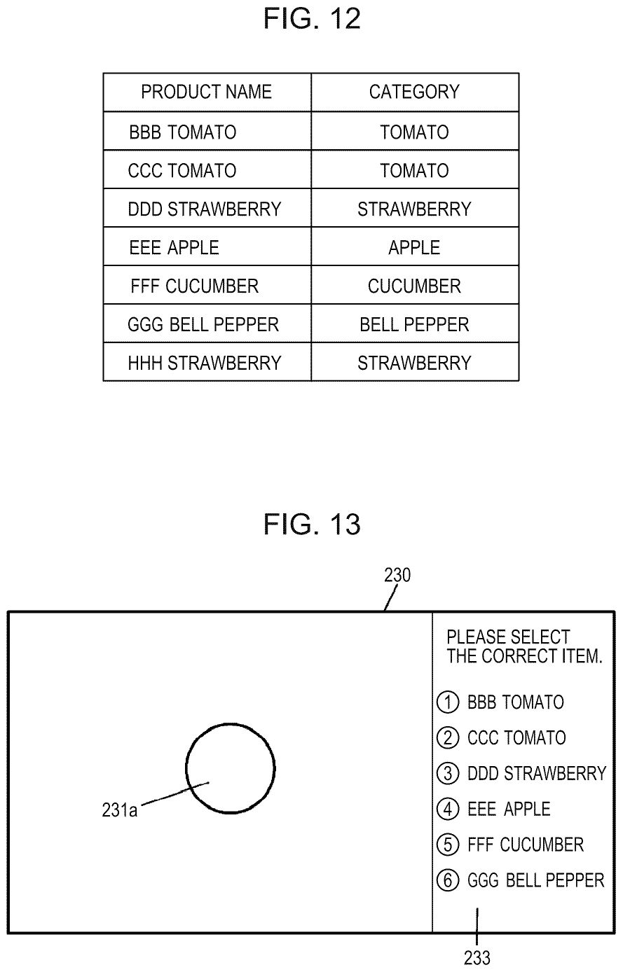

Upon accepting touch input on the image indicating “Not any of these”, the control unit 24 references a misrecognition list 260 that defines items defined in advance to be easily misrecognized as each other, and displays, as the third candidates 42, items defined to be easily misrecognized as the second candidate 41a with the highest confidence. In the misrecognition list, each item is defined in association with another item that is easily misrecognized as the item. An item defined in advance to be easily misrecognized is another item that satisfies a certain confidence when the first item 31a is recognized, an item that has been corrected from the first item 31a by other users a number of times exceeding a prescribed number of times, an item for which the similarity of item feature information satisfies a prescribed similarity, or the like. From among “AAA tomato”, “BBB tomato”, “CCC tomato”, and “FFF tomato” which are the second candidates 41 displayed in the image 30, the control unit 24 extracts, from the misrecognition list, the misrecognition list 260 for “AAA tomato” with the highest confidence. FIG. 12 illustrates an example of the list 260.

The control unit 24 determines the items included on the misrecognition list 260 as the third candidates 242. For example, the control unit 24 determines, as third candidates 242, “BBB tomato”, “CCC tomato”, “DDD strawberry”, “EEE apple”, “FFF cucumber”, “GGG bell pepper”, and “HHH strawberry” included on the misrecognition list 260 for “AAA tomato” which is the second candidate 41a.

The control unit 24 displays an image 230 on the display unit 13. FIG. 13 illustrates an example of the image 230. The image 230 includes a captured image 231 and an image 233. The display of the captured image 231 is the same and/or similar to the captured image 31 described above. The image 233 includes the item names of the third candidates 242. For example, the displayed image 230 includes “BBB tomato”, “CCC tomato”, “DDD strawberry”, “EEE apple”, “FFF cucumber”, “GGG bell pepper”, and “HHH strawberry” which are the third candidates 242. At this time, the image 233 may include a portion of the items registered on the list. Note that instead of displaying all of the third candidates 242, the control unit 24 may display more easily confused items from among the third candidates 242 on the display unit 13. At this time, the control unit 24 may calculate the degree to which an item is easily confused on the basis of at least one of the following: the confidences of the plurality of third candidates 242 calculated when the first item 31a was recognized; the number of times the first item 31a has been corrected by the plurality of third candidates 242 by other users; and the similarity of item feature information. For example, the image 233 may include only the more easily confused items “BBB tomato”, “CCC tomato”, and “DDD strawberry” from among “BBB tomato”, “CCC tomato”, “DDD strawberry”, “EEE apple”, “FFF cucumber”, “GGG bell pepper”, and “HHH strawberry” which are the third candidates 242. The image 233 need not include an item that is included among the third candidates 242 and also included among the second candidates 41. For example, from among “BBB tomato”, “CCC tomato”, and “DDD strawberry”, which are the more easily confused items among the third candidates 242, the image 233 may include only “DDD strawberry”, excluding “BBB tomato” and “CCC tomato” which are included among the second candidates 41. At this time, the image 233 may include “EEE apple” and “FFF cucumber” in addition to “DDD strawberry”.

In this way, when displaying new candidates, by displaying items defined in advance to be easily misrecognized as each other, user operations can be reduced and the correct item can be presented to the user, enabling the user to complete the payment process quickly.

### System Operations in Variation 2

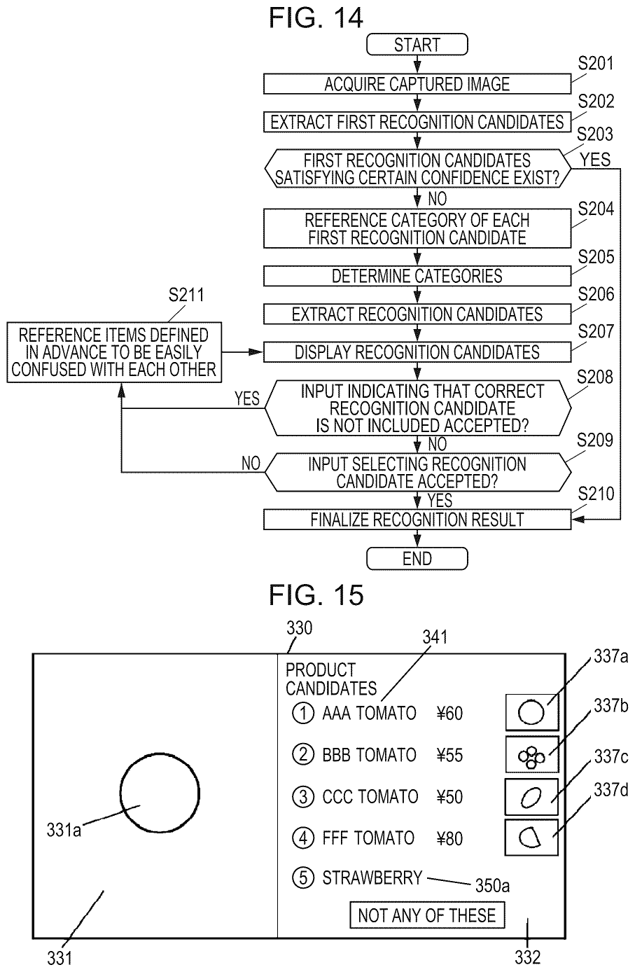

FIG. 14 is a flowchart illustrating a procedure of an information processing method according to an embodiment of variation 2 of the present disclosure. The information processing method includes steps S201 to S211. For example, the control unit 24 starts the processing in step S201 upon accepting, via the input unit 22, input giving an instruction to start accounting.

Since the processing in steps S201 to S210 is the same and/or similar to the processing in steps S101 to S110 described above, description is omitted.

In the processing in step S211, the control unit 24 references the misrecognition list and determines the third candidates 242. For example, the control unit 24 determines, as the third candidates 242, the list 260 of items easily misrecognized as “AAA tomato”.

After the processing in step S211, the flow returns to the processing in step S207. At this time, the third candidates 242 determined in step S211 are handled as the second candidates 42 in the processing from step S207.

### Variation 3

The following describes variation 3. Variation 3 is an embodiment that involves changing the image to be displayed on the display unit 13 in the display process in the first embodiment. Note that description is omitted for portions of the process that overlap with the display process described above.

The control unit 24 may display an image 330 instead of the image 30 on the display unit 13. FIG. 15 illustrates the image 330. The image 330 includes a captured image 331 and an image 332. The captured image 331 is an image captured by the first imaging unit 12. The captured image 31 includes an image of a first item 31a that the user placed on the top surface 10s of the placing table 10. In the image 332, the item names of second candidates 341 determined by the control unit 24 are displayed. In the image 332, the item name of the second 341a with the highest confidence among the second candidates 341 is displayed with greater emphasis than the other second candidates 341. For example, “AAA tomato”, which is the second candidate 341a with the highest confidence, may be displayed such that the text size is increased, the text thickness is increased, or the text color is changed with respect to the item names of the other second candidates 341. The displayed image 332 includes the item names of the second candidates 341 along with registered images 337 of the items. The registered images 337 are images of items stored in the storage unit 23. The displayed image 332 includes the item names of the second candidates 341 along with information pertaining to the prices of the items.

The displayed image 332 may include, in addition to the second candidates 341, at least one other category, excluding the first category 51, from among the categories 50 to which belong the first candidates 40a to 40h referenced by the control unit 24. For example, from among the referenced categories “tomato”, “strawberry”, “apple”, and “bell pepper”, the display may include at least one from among “strawberry”, “apple”, and “bell pepper”, excluding “tomato” which is the first category 51. The at least one category to be included in the display of the image 332 may be the category to which belongs the greatest number of the first candidates 40, on the basis of the number of the plurality of first candidates 40 belonging to that category. In the present embodiment, the breakdown of the numbers of first candidates belonging to the categories is as follows: two for “strawberry”, one for “apple”, and one for “bell pepper”. Thus, the display may additionally include only “strawberry”, which is the category to which belongs the greatest number of first candidates 40 from among the above categories. When the displayed image 332 includes a category, the display of the category may be differentiated from the display of the second candidates 341. In variation 3, when displaying the other category “strawberry”, only the text “strawberry” is displayed in italics. The user selects the item name of the second candidate 341 that is the first item 31a or the category 50 to which the first item 31a belongs.

### Variation 4

The following describes variation 4. Variation 4 involves changing the image to be displayed on the display unit 13 in the display process and the correction process in variation 1. Note that description is omitted for portions of the process that overlap with the display process described above.

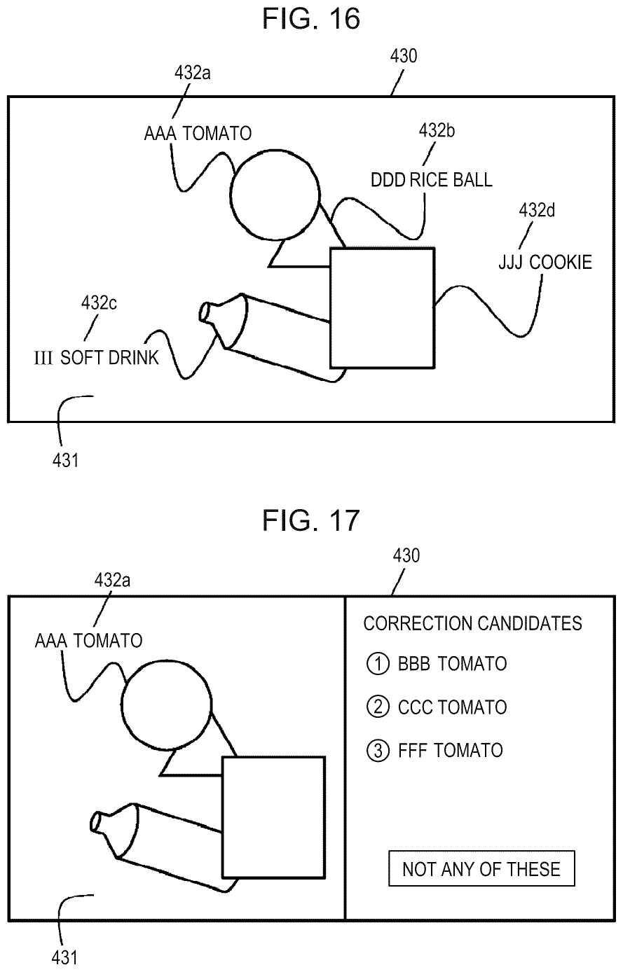

The control unit 24 displays an image 430 instead of the image 130 on the display unit 13. FIG. 16 illustrates an example of the image 430. The image 430 includes a captured image 431. The captured image 431 includes images of a plurality of items placed on the placing table 10, and recognition results 432a to 432d obtained by performing object recognition processing on the plurality of items. The user checks the plurality of items and corresponding recognition results 432a to 432d included in the captured image 431. If the first recognition result 432a, which is the recognition result for a first item 431a included among the plurality of items, is wrong, the user enters input for correcting the first recognition result 432a into the input unit 22. More specifically, this process is the same and/or similar to variation 1, and thus description is omitted.

Upon accepting, via the input unit 22, input for correcting the first recognition result 132a, the control unit 24 additionally displays an image 436 in the image 130. FIG. 17 illustrates an example of the image 436. The displayed image 436 includes the first recognition result 432a and a second candidate 441 with a high probability of being the correct item name of the first item 431a. The image 436 displayed at this time includes one or more second candidates 441. The second candidates 441 are candidates determined by the display process described above. The displayed image 436 may include a button for inputting an indication that the first item 431a is not included among the second candidates 441. For example, the displayed image 436 may include an image indicating “Not any of these” as the button for inputting an indication that the first item 431a is not included among the second candidates 441.

The present disclosure has been described on the basis of the drawings and examples, but note that a person skilled in the art could easily make various variations or revisions on the basis of the present disclosure. Consequently, it should be understood that these variations, revisions, and/or combinations of the examples in the present disclosure are included in the scope of the present disclosure.

In the present disclosure, qualifiers such as “first” and “second” are identifiers for distinguishing configurations. The numerals denoting the configurations distinguished by qualifiers such as “first” and “second” in the present disclosure are interchangeable. For example, the first candidate can interchange the identifiers “first” and “second” with the second candidate. The identifiers are interchanged at the same time. The configurations are still distinguished after the interchange of the identifiers. The identifiers may be removed. The configurations with the identifiers removed therefrom are distinguished by signs. The description of identifiers such as “first” and “second” in the present disclosure shall not be used as a basis for interpreting the order of the configurations or the existence of identifiers with smaller numbers.

The input selecting an image of an item and a recognition result for an item displayed on the display unit 13 in the present disclosure is not limited to the above-described, and the selection may also be performed for a prescribed time or longer.
In an embodiment, (1) an information processing device includes:
an acquisition unit configured to acquire a captured image of an item; and
a control unit configured to display a first candidate satisfying a prescribed condition as a second candidate, the first candidate being from among a plurality of first candidates that are recognition results for the item based on the captured image.
(2) In the information processing device according to (1) above, the control unit is configured to output, as the second candidate, the recognition result belonging to a first category to which belongs the greatest number of the first candidates from among a plurality of categories.
(3) The information processing device according to (1) above, wherein the control unit is configured to output, as the second candidate, the recognition result belonging to a first category to which belongs the first candidate with a highest confidence from among a plurality of categories.
(4) The information processing device according to (2) or (3) above, wherein the control unit is configured to determine a category to which the item belongs according to a type or a shape of the item.
(5) The information processing device according to any one of (2) to (4) above, wherein the control unit is configured to select a second category, the second category being a category to which the first candidate belongs and which is a different category from the first category.
(6) The information processing device according to (5) above, further including:
an input unit configured to accept input from a user, wherein
the control unit is configured to output information on an item belonging to a category entered from the input unit from among a plurality of second categories.
(7) The information processing device according to any one of (1) to (4) above, further including:
an input unit configured to accept input from a user, wherein
the control unit is configured to output, in response to input from the input unit, an item defined in advance to be an item for which the item and the second candidate with a highest confidence are easily misrecognized as each other.
In an embodiment, (8) an information processing method includes:
acquiring a captured image of an item; and
displaying, on a display unit, a first candidate satisfying a prescribed condition as a second candidate, the first candidate being from among a plurality of first candidates that are recognition results for the item.
In an embodiment, (9) a display device includes:
a display unit configured to display a first candidate satisfying a prescribed condition as a second candidate, the first candidate being from among a plurality of first candidates that are recognition results for an item included in a captured image.

### REFERENCE SIGNS

1 payment system
2 network
3 information processing system
4 server
10 placing table
10s top surface
11 support post
12 first imaging unit
13 display unit
14 second imaging unit
20 information processing device
21 communication unit
22 input unit
23 storage unit
24 control unit
31, 131, 231 captured image
31a, 131a first item
40, 40a, 40b, 40c, 40d, 40e, 40f, 40g, 40h first candidate
41, 141, 141a, 141b, 141c second candidate
42, 242 third candidate
50 category
51 first category
52 second category

1. An information processing device comprising:
an acquisition unit is configured to acquire a captured image of an item; and
a control unit is configured to display a first candidate satisfying a prescribed condition as a second candidate, the first candidate being from among a plurality of first candidates that are recognition results for the item based on the captured image.

2. The information processing device according to claim 1, wherein the control unit is configured to output, as the second candidate, the recognition result belonging to a first category to which belongs a greatest number of the first candidates from among a plurality of categories.

3. The information processing device according to claim 1, wherein the control unit is configured to output, as the second candidate, the recognition result belonging to a first category to which belongs the first candidate with a highest confidence from among a plurality of categories.

4. The information processing device according to claim 2, wherein the control unit is configured to determine a category to which the item belongs according to a type or a shape of the item.

5. The information processing device according to claim 2, wherein the control unit is configured to select a second category, the second category being a category to which the first candidate belongs and which is a different category from the first category.

6. The information processing device according to claim 5, further comprising:
an input unit configured to accept input from a user, wherein
the control unit is configured to output information on an item belonging to a category entered from the input unit from among a plurality of second categories.

7. The information processing device according to claim 1, further comprising:
an input unit configured to accept input from a user, wherein
the control unit is configured to output, in response to input from the input unit, an item defined in advance to be an item for which the item and the second candidate with a highest confidence are easily misrecognized as each other.

8. An information processing method comprising:
acquiring a captured image of an item; and
displaying, on a display unit, a first candidate satisfying a prescribed condition as a second candidate, the first candidate being from among a plurality of first candidates that are recognition results for the item.

9. A display device comprising:
a display unit configured to display a first candidate satisfying a prescribed condition as a second candidate, the first candidate being from among a plurality of first candidates that are recognition results for an item included in a captured image.
